(19) United States
(12) Patent Application Publication
(10) Pub. No.: US 2023/0027931 A1
(43) Pub. Date: Jan. 26, 2023

(54) THERMOPLASTIC MOULDING COMPOSITION CONTAINING POLYALKYLENE TEREPHTHALATE

(71) Applicant: BASF SE, Ludwigshafen (DE)

(72) Inventors: Anna Maria Mueller-Cristadoro, Lemfoerde (DE); Martin Weber, Ludwigshafen (DE); Peter Eibeck, Ludwigshafen (DE)

(21) Appl. No.: 17/782,753

(22) PCT Filed: Dec. 16, 2020
(86) PCT No.: PCT/EP2020/086380

§ 371 Date: Jun. 6, 2022

(30) Foreign Application Priority Data
Dec. 16, 2019 (EP) 19216713.8

(51) Int. Cl. C08L 67/02

(52) U.S. Cl. CPC C08L 67/02

(57) ABSTRACT

The present invention relates to a thermoplastic molding compound comprising a polyalkylene terephthalate and a polyimide, wherein the molding compound has a single glass transition temperature in DSC measurement. The present invention further relates to the use thereof and to fibers, films and shaped bodies produced from the molding compound.

The present invention relates to a thermoplastic molding compound comprising a polyalkylene terephthalate and a polyimide, wherein the molding compound has a single glass transition temperature. The present invention further relates to the use thereof and to fibers, films and shaped bodies produced from the molding compound.

Polyalkylene terephthalates are polyesters and have thermoplastic properties. They have a wide variety of possible applications. Polyethylene terephthalate (PET) in particular plays an important role. PET is used inter alia for producing plastic bottles (PET bottles), films and textile fibers. Polybutylene terephthalate (PBT) has good properties. PBT is preferred over PET due to better processing characteristics, this being especially important in injection molding processes. However, the starting materials for PBT are more costly.

A disadvantage of polyalkylene terephthalates is their relatively low glass transition temperature (T_{g}). This limits the temperature range for the hard elastic state in which polyalkylene terephthalates are often employed and it is desirable to expand this temperature range/to increase the glass transition temperature. It is likewise desirable to retain the properties of the polyalkylene terephthalates, such as their crystallinity, to the greatest possible extent and to achieve the increase via additives in a molding compound.

It is accordingly an object of the present invention to provide such a molding compound.

The object was achieved by a thermoplastic molding compound comprising a polyalkylene terephthalate and a polyimide, wherein the molding compound has a single glass transition temperature in DSC measurement.

It has surprisingly been found that mixtures of polyalkylene terephthalate and polyimide form only one amorphous phase, so that heating of the mixtures reveals only a single glass transition temperature and the glass transitions of the components polyalkylene terephthalate and polyimide no longer occur.

In the context of the present invention the term “molding compound” is used according to its generally understood definition. Molding compounds are accordingly unshaped products which can be shaped by mechanical forces in a particular temperature range. Suitable processes are for example extruding, injection molding and pressing.

The glass transition temperature (T_{g}) is known to those skilled in the art and represents a characteristic physical parameter of a polymer or a mixture of two or more polymers. At this temperature a solid polymer or glass is converted into a rubber-like to viscous state. This may be determined for example by dynamic scanning calorimetry (DSC).

The thermoplastic molding compound according to the invention has a single glass transition temperature. The expression “a single glass transition temperature” is in the context of the present invention to be understood in simplified form as meaning that the polymers polyimide and polyalkylene terephthalate form a mixed phase having a T_{g} value between the T_{g} values of the components. Further auxiliaries that may be present in the thermoplastic molding material according to the invention may themselves have a polymeric, amorphous nature and have a glass transition temperature but are not to be taken into account in the context of having “a single glass transition temperature”.

Such a single glass transition temperature T_{g} preferably has a value of at least 45° C. A T_{g} value of at least 50° C. is more preferred. A T_{g} value of at least 60° C. is yet more preferred. A T_{g} value of at least 70° C. is yet more preferred. A T_{g} value of at least 80° C. is yet more preferred.

According to the invention polyimide which is characterized by a high T_{g} value is to be used to increase the T_{g} value of the polyalkylene terephthalate which is typically low. Accordingly the T_{g} value of the thermoplastic molding compound is in the range beginning with the T_{g} value of the polyalkylene terephthalate and ending with the T_{g} value of the polyimide.

It is preferable when the difference between the T_{g} value of the polyalkylene terephthalate and the T_{g} value of the polyimide before these have been introduced into the molding compound according to the invention is at least 25° C., more preferably at least 50° C., more preferably at least 75° C., more preferably at least 100° C., more preferably at least 125° C., more preferably at least 130° C., more preferably at least 140° C.

It is preferable when the difference (increase) between the T_{g} value of the polyalkylene terephthalate before this has been introduced into the molding compound according to the invention and the T_{g} value of the polyalkylene terephthalate in the molding compound according to the invention (mixed phase) is at least 5° C., more preferably at least 10° C., more preferably at least 15° C., more preferably at least 20° C., more preferably at least 25° C., more preferably at least 30° C., more preferably at least 40° C.

The thermoplastic molding compound according to the present comprises a polyalkylene terephthalate. This is preferably a polyethylene, polytrimethylene or polybutylene terephthalate or a mixture thereof. It is more preferably a polybutylene terephthalate.

Polyalkylene terephthalates (A) are commercially available and may comprise at least partially amorphous forms. In the context of the present invention the polyalkylene terephthalate may have a glass transition temperature assigned to it.

Commercially available polybutylene terephthalates (A) are marketed by BASF as the Ultradur® series for example. One example is Ultradur® B4500.

Commercially available polyethylene terephthalates (A) are marketed by BASF as the Petra® series for example.

The thermoplastic molding compound according to the present invention further comprises a polyimide (B).

Polyimides (B) are thermally and mechanically very stable polymers. In order to be able to employ these polymers as thermoplastics irregularities are incorporated into the polymer chain. Branchings in the polymer scaffold may be provided for example. These branchings make it possible to avoid crystallinity and adjust the T_{g} value.

An exemplary synthesis of polyimides is shown below, wherein only one polymer unit is shown as an extract for simplicity.

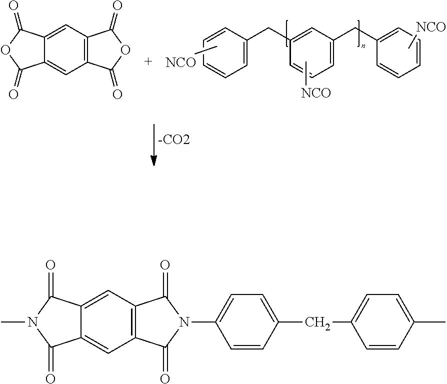

The presence of small amounts of water can have a catalytic effect in the reaction, wherein the elimination of carbon dioxide results for example in polyimides soluble in NMP.

The catalytic effect of water is shown in the following reaction sequence:

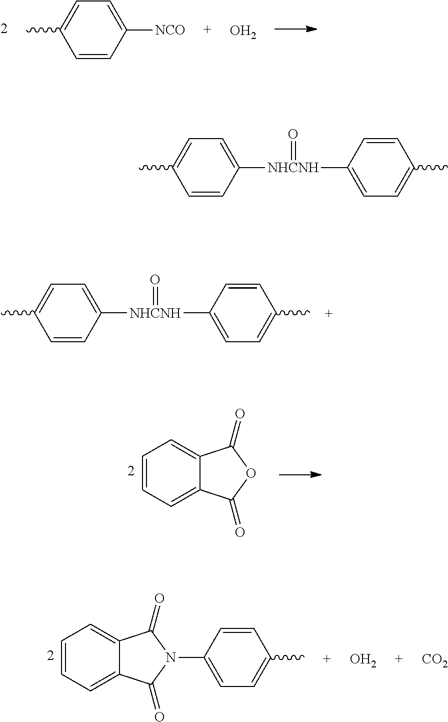

Production of polyimides is known for example from WO 2012/163680 A1 and is more particularly described hereinbelow. Polyimides may be formed for example from:

IA at least one isocyanate, wherein the isocyanate comprises at least two isocyanate groups (“polyisocyanate”), preferably having at least an average of more than two isocyanate groups per molecule.

b2) at least one amine, wherein the amine comprises at least two amino groups (“polyamine”), preferably having at least an average of more than two amino groups per molecule and

b3) at least one polycarboxylic acid having at least three, preferably at least four COOH groups, in particular precisely 4 per molecule, or their anhydride, in particular the dianhydride.

The combination b1) and b3) is preferred.

The polyimide (B) is especially preferably obtained by reaction of at least one carboxylic dianhydride with at least one isocyanate, wherein the isocyanate comprises at least two, preferably more than two, isocyanate groups.

Polyimide (B) may have a molecular weight Mw in the range from 1000 to 200 000 g/mol, preferably at least 2000 g/mol.

Polyimide (B) may have at least two imide groups per monomer unit, preferably at least 3 imide groups per monomer unit.

In one embodiment of the present invention polyimide (B) may comprise up to 1000 imide groups per molecule, preferably up to 660 per molecule. In one embodiment of the present invention the reported number of isocyanate groups/COOH groups per molecule in each case refers to the average (number average).

Polyimide (B) may be composed of structurally and molecularly uniform molecules. However, it is preferable when polyimide (B) is a mixture of molecularly and structurally distinct molecules, for example visible in the polydispersity Mw/Mn of at least 1.4; Mw/Mn is preferably from 1.4 to 50, more preferably from 1.5 to 10. Polydispersity may be determined by known methods, in particular by gel permeation chromatography (GPC). A suitable standard is for example polymethyl methacrylate (PMMA). In addition to imide groups which form the polymer scaffold the polyimide (B) may further comprise at terminal or pendant positions at least three, preferably at least six, particularly preferably at least 10, terminal or pendant functional groups. Functional groups in the polyimide (B) may be for example anhydride or acid groups and/or free or capped NCO groups. Polyimides (B) by preference comprise not more than 500 terminal or pendant functional groups, preferably not more than 100.

Polyisocyanate (b1) may be selected from any desired polyisocyanates which on average comprise at least or preferably more than two isocyanate groups per molecule which may be capped or preferably free. Preference is given to trimeric or oligomeric diisocyanates, for example oligomeric hexamethylene diisocyanate, oligomeric isophorone diisocyanate, oligomeric tolylene diisocyanate, oligomeric diphenylmethane diisocyanate—so called polymer MDI—and mixtures of the abovementioned polyisocyanates. So-called trimeric hexamethylene diisocyanate is in many cases not in the form of pure trimeric diisocyanate but rather in the form of polyisocyanate having an average functionality of 3.6 to 4 NCO groups per molecule. The analogous applies for oligomeric tetramethylene diisocyanate and oligomeric isophorone diisocyanate.

The abovementioned polyisocyanates are commercially available or producible by known methods. For example polymeric MDI is obtainable as Lupramat®. For example Lupramat M20 has an average isocyanate functionality of 2.7.

In one embodiment of the present invention the polyisocyanate is a polyisocyanate having more than two isocyanate groups per molecule, a mixture of at least one diisocyanate and at least one triisocyanate or a polyisocyanate having at least 4 isocyanate groups per molecule.

In one embodiment of the present invention polyisocyanate (b1) has on average at least 2.2, preferably at least 2.5, particularly preferably at least 3.0, isocyanate groups per molecule.

In one embodiment of the present invention polyisocyanate (b1) is selected from oligomeric hexamethylene diisocyanate, oligomeric isophorone diisocyanate, oligomeric diphenylmethane diisocyanate and mixtures of the abovementioned polyisocyanates.

Polyisocyanate (b1) may comprise not only isocyanate groups but also one or more other functional groups, for example urethane, urea, allophanate, biuret, carbodiimide, amide, esters, ethers, uretonimine, uretdione, isocyanurate or oxazolidine groups. In a second variant a polyamine (b2) and a polycarboxylic acid b3) and/or a polycarboxylic ester (b3) may be reacted with one another analogously to the process described in US 2010/009206 A1. The polyamine (b2) may be selected from any desired polyamines which on average comprise more than two isocyanate groups per molecule which may be capped or preferably free.

Suitable polyamines (b2) also include the compounds recited in US 2010/009206 A1, such as for example 3,5-di(4-aminophenoxy)aniline, 3,5-di(3-methyl-1,4-aminophenoxy)aniline, 3,5-di(3-methoxy-4-aminophenoxy)aniline, 3,5-di(2-methyl-4-aminophenoxy)aniline, 3,5-di(2-methoxy-4-aminophenoxy)aniline, 3,5-di(3-ethyl-4-aminophenoxy)aniline and comparable substances. Also suitable are amines such as 1,3,5-tri(4-aminophenoxy)benzene, 1,3,5-tri(3-methyl-1,4-aminophenoxy)benzene, 1,3,5-tri(3-methoxy-4-aminophenoxy)benzene, 1,3,5-tri(2-methyl-4-aminophenoxy)benzene, 1,3,5-tri(2-methoxy-4-aminophenoxy)benzene, 1,3,5-tri(3-ethyl-4-aminophenoxy)benzene. It is also possible to employ as aromatic triamines 1,3,5-tri(4-aminophenylamino)benzene, 1,3,5-tri(3-methyl-4-aminophenylamino)benzene, 1,3,5-tri(3-methoxy-4-aminophenylamino)benzene, 1,3,5-tri(2-methyl-4-aminophenylamino)benzene, 1,3,5-tri(2-methoxy-4-aminophenylamino)benzene, 1,3,5-tri(3-ethyl-4-aminophenylamino)benzene and the like.

Further aromatic triamine are 1,3,5-tri(4-aminophenyl)benzene, 1,3,5-tri(3-methyl-4-aminophenyl)benzene, 1,3,5-tri(3-methoxy-4-aminophenyl)benzene, 1,3,5-tri(2-methyl-4-aminophenyl)benzene, 1,3,5-tri(2-methoxy-4-aminophenyl)benzene, 1,3,5-tri(3-ethyl-4-aminophenyl)benzene and similar compounds.

Also suitable are 1,3,5-tri(4-aminophenyl)amine, 1,3,5-tri(3-methyl-4-aminophenyl)amine, 1,3,5-tri(3-methoxy-4-aminophenyl)amine, 1,3,5-tri(2-methyl-4-aminophenyl)amine, 1,3,5-tri(2-methoxy-4-aminophenyl)amine, 1,3,5-tri(3-ethyl-4-aminophenyl)amine and similar compounds.

Further examples are tris(4-(4-aminophenoxy)phenyl)methane, tris(4-(3-methyl-4-aminophenoxy)phenyl)methane, tris(4-(3-methoxy-4-aminophenoxy)phenyl)methane, tris(4-(2-methyl-4-aminophenoxy)phenyl)methane, tris(4-(2-methoxy-4-aminophenoxy)phenyl)methane, tris(4-(3-ethyl,4-aminophenoxy)phenyl)methane and comparable compounds.

Suitable amines further include tris(4-(4-aminophenoxy)phenyl)ethane, tris(4-(3-methyl-4′-aminophenoxy)phenyl)ethane, tris(4-(3-methoxy-4-aminophenoxy)phenyl)ethane, tris(4-(2-methyl-4-aminophenoxy)phenyl)ethane, tris(4-(2-methoxy-4-aminophenoxy)phenyl)ethane, tris(4-(3-ethyl-4-aminophenoxy)phenyl)ethane and the like.

It is also possible to employ the polyamines recited in US 2006/033225 A1. It is also possible to employ for example 3,3′,4,4′-biphenyltetraamine (TAB), 1,2,4,5-benzentetraamine, 3,3′,4,4′-tetraaminodiphenyl ether, 3,3′,4,4′-tetraaminodiphenylmethane, 3,3′,4,4′-tetraaminobenzophenone, 3,3′,4-triaminobiphenyl, 3,3′,4-triaminodiphenylmethane, 3,3′,4-triaminobenzophenone, 1,2,4-triaminobenzene and the mono-, di-, tri-, or tetra-acid salts thereof such as 2,4,6-triaminopyrimidine (TAP).

Polycarboxylic acids (b3) employed are selected from aliphatic or preferably aromatic polycarboxylic acids comprising at least three COOH groups per molecule or the respective anhydrides, preferably when they are in low molecular weight, i.e. non-polymeric, form. Polycarboxylic acids having three COOH groups where two carboxylic acid groups are in the form of anhydride and the third is in the form of a free carboxylic acid are also comprehended. In a preferred embodiment of the present invention the polycarboxylic acid (b3) is selected from a polycarboxylic acid having at least four COOH groups per molecule or the respective anhydride, in particular the dianhydride.

Examples of polycarboxylic acids (b3) and their anhydrides are 1,2,3-benzenetricarboxylic acid and 1,2,3-benzenetricarboxylic dianhydride, 1,3,5-benzenetricarboxylic acid (trimesic acid), preferably 1,2,4-benzenetricarboxylic (trimellitic acid), trimellitic anhydride and in particular 1,2,4,5-benzenetracarboxylic acid (pyromellitic acid) and 1,2,4,5-benzenetracarboxylic dianhydride (pyromellitic dianhydride), 3,3′,4,4″-benzophenonetetracarboxylic acid, 3,3′,4,4″-benzophenonetetracarboxylic dianhydride, also benzenehexacarboxylic acid (mellitic acid) and anhydrides of mellitic acid.

Also suitable are mellophanic acid and mellophanic anhydride, 1,2,3,4-benzenetetracarboxylic acid and 1,2,3,4-benzenetetracarboxylic dianhydride, 3,3,4,4-biphenyltetracarboxylic acid and 3,3,4,4-biphenyltetracarboxylic dianhydride, 2,2,3,3-biphenyltetracarboxylic acid and 2,2,3,3-biphenyltetracarboxylic dianhydride, 1,4,5,8-naphthalenetetracarboxylic acid and 1,4,5,8-naphthalenetetracarboxylic dianhydride, 1,2,4,5-naphthalenetetracarboxylic acid and 1,2,4,5-naphthalenetetracarboxylic dianhydride, 2,3,6,7-naphthalenetetracarboxylic acid and 2,3,6,7-naphthalenetetracarboxylic dianhydride, 1,4,5,8-decahydronaphthalenetetracarboxylic acid and 1,4,5,8-decahydronaphthalenetetracarboxylic dianhydride, 4,8-dimethyl-1,2,3,5,6,7-hexahydronaphthalene-1,2,5,6-tetracarboxylic acid and 4,8-dimethyl-1,2,3,5,6,7-hexahydronaphthalene-1,2,5,6-tetracarboxylic dianhydride, 2,6-dichloronaphthalene-1,4,5,8-tetracarboxylic acid and 2,6-dichloronaphthalene-1,4,5,8-tetracarboxylic dianhydride, 2,7-dichloronaphthalene-1,4,5,8-tetracarboxylic acid and 2,7-dichloronaphthalene-1,4,5,8-tetracarboxylic dianhydride, 2,3,6,7-tetrachloronaphthalene-1,4,5,8-tetracarboxylic acid and 2,3,6,7-tetrachloronaphthalene-1,4,5,8-tetracarboxylic dianhydride, 1,3,9,10-phenanthrenetetracarboxylic acid and 1,3,9,10-phenanthrenetetracarboxylic dianhydride, 3,4,9,10-perylenetetracarboxylic acid and 3,4,9,10-perylenetetracarboxylic dianhydride, bis(2,3-dicarboxphenyl)methane and bis(2,3-dicarboxyphenyl)methane dianhydride, bis(3,4-dicarboxphenyl)methane and bis(3,4-dicarboxyphenyl)methane dianhydride, 1,1-bis(2,3-dicarboxphenyl)ethane and 1,1-bis(2,3-dicarboxyphenyl)ethane dianhydride, 1,1-bis(3,4-dicarboxphenyl)ethane and 1,1-bis(3,4-dicarboxyphenyl)ethane dianhydride, 2,2-bis(2,3-dicarboxphenyl)propane and 2,2-bis(2,3-dicarboxyphenyl)propane dianhydride, 2,3-bis(3,4-dicarboxphenyl)propane and 2,3-bis(3,4-dicarboxphenyl)propane dianhydride, bis(3,4-carboxyphenyl)sulfone and bis(3,4-carboxyphenyl)sulfone dianhydride, bis(3,4-carboxyphenyl)ether and bis(3,4-carboxyphenyl)ether dianhydride, ethylenetetracarboxylic acid and ethylenetetracarboxylic dianhydride, 1,2,3,4-butanetetracarboxylic acid and 1,2,3,4-butanetetracarboxylic dianhydride, 1,2,3,4-cyclopentanetetracarboxylic acid and 1,2,3,4-cyclopentanetetracarboxylic dianhydride, 2,3,4,5-pyrrolidinetetracarboxylic acid and 2,3,4,5-pyrrolidinetetracarboxylic dianhydride, 2,3,5,6-pyrazinetetracarboxylic acid and 2,3,5,6-pyrazinetetracarboxylic dianhydride, 2,3,4,5-thiophenetetracarboxylic acid and 2,3,4,5-thiophenetetracarboxylic dianhydride.

It is preferable when the at least one carboxylic dianhydride is 1,2,4,5-benzentetracarboxylic anhydride.

In one embodiment of the present invention anhydrides from U.S. Pat. No. 2,155,687 A or U.S. Pat. No. 3,277,117 A are used to synthesize polyimide (B).

Production of the polyimide (B) may follow the mechanism shown in the following formula. Reacting a polyisocyanate (b1) and a polycarboxylic acid (b3) with one another preferably in the presence of a catalyst forms an imide group by elimination of CO₂ and H₂O. Reacting a polyisocyanate (b1) and a corresponding anhydride (b3) with one another forms an imide group by elimination of CO₂.

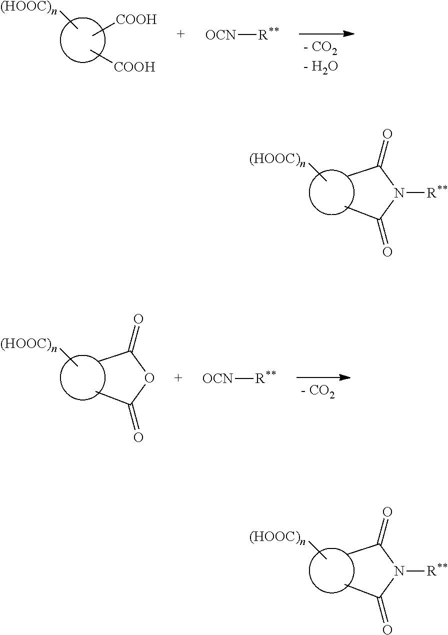

In the above formula R** is a polyisocyanate (b2) radical which is not further specified in the formula and n is a number not less than 1. If n is 1 for example this is a tricarboxylic acid. If n=2 for example this is a tetracarboxylic acid. (HOOC)n may be replaced by C(═O)—O—C(═O) or an ester radical.

Reacting a polyamine (b2) and the polycarboxylic acid (b3)/the corresponding anhydride (b3) preferably in the presence of a catalyst forms an imide moiety with elimination of water.

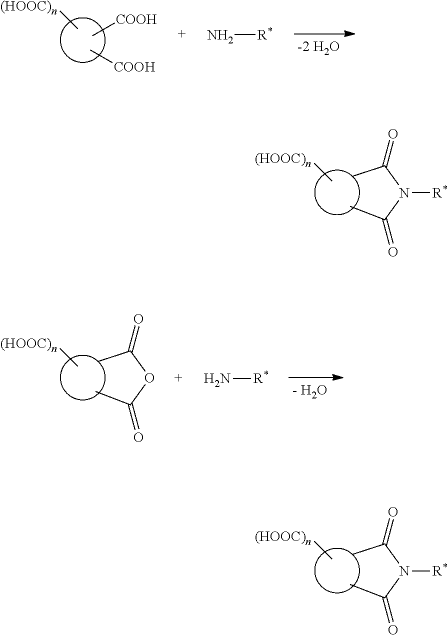

In the above formula R* is a polyamine (b2) radical which is not further specified in the formula. n is a number not less than 1. In the case of a tricarboxylic acid n=1. In the case of a tetracarboxylic acid n=2. (HOOC)n may be replaced by a C(═O)—O—C(═O) radical or an ester.

Polyimide B) may be produced for example by the process described below.

Polyisocyanate (b1) and polycarboxylic acid (b3) are condensed with one another—preferably in the presence of a catalyst—to form an imide group by elimination of CO₂ and H₂O. If the corresponding anhydride is employed instead of polycarboxylic acid (b3) an imide group is formed by elimination of CO₂.

Suitable catalysts include in particular water and Brønsted bases, for example alkali metal alkoxides, in particular alkoxides of sodium or potassium, for example sodium methoxide, sodium ethoxide, sodium phenoxide, potassium methoxide, potassium ethoxide, potassium phenoxide, lithium methoxide, lithium oxide and lithium phenoxide. The catalyst may be employed in the range from 0.005% to 0.1% by weight of catalyst based on the sum of polyisocyanate (b1) and polycarboxylic acid (b3)/polyisocyanate (b1) and anhydride (b3). 0.01% to 0.05% by weight of catalyst are preferred.

In the case where polyisocyanate (b1) comprises >2 isocyanate groups this may be employed in admixture with at least one diisocyanate, for example with tolylene diisocyanate, hexamethylene diisocyanate or with isophorone diisocyanate. In a particular variant polyisocyanate (b1) is employed in admixture with the corresponding diisocyanate, for example trimeric HDI mit hexamethylene diisocyanate or trimeric isophorone diisocyanate with isophorone diisocyanate or oligomeric diphenylmethane diisocyanate (polymeric MDI) with diphenylmethane diisocyanate.

In a particularly preferred embodiment the at least one isocyanate is 4,4′-diphenylmethane diisocyanate, oligomeric 4,4′-diphenylmethane diisocyanate, 2,4-toluene diisocyanate or 2,6-toluene diisocyanate or a mixture thereof. It is especially preferable to employ at least three isocyanates, in particular a mixture of oligomeric 4,4′-diphenylmethane diisocyanate, 2,4-toluene diisocyanate and 2,6-toluene diisocyanate. It is preferable when the molar ratio of 2,4-toluene diisocyanate to 2,6-toluene diisocyanate is in the range from 1:1 to 10:1, more preferably 1.5:1 to 8:1, more preferably 2:1 to 6:1, more preferably 3:1 to 5:1 and in particular 4:1.

The molar ratio of oligomeric 4,4-diphenylmethane diisocyanate to the sum of 2,4-toluene diisocyanate and 2,6-toluene diisocyanate is preferably in the range from 1:1 to 0.1:1, more preferably from 0.8:1 to 0.2:1, more preferably from 0.7:1 to 0.3, more preferably from 0.5:1 to 0.4:1.

The polycarboxylic acid (b3) may be employed in admixture with at least one dicarboxylic acid or with at least one dicarboxylic anhydride, for example with phthalic acid or phthalic anhydride.

In one embodiment of the present invention the polyimide (B) employed is a hyperbranched polyimide. In the context of the present invention the term “hyperbranched” is to be understood as meaning that the degree of branching (DB), i.e. the average number of dendritic bonds plus the average number of end groups per molecule, divided by the sum of the average number of dendritic, linear and terminal bonds, multiplied by 100, is 10% to 99.9%, preferably 20% to 99%, particularly preferably 20% to 95%. In the context of the present invention “dendrimer” is to be understood as meaning that the degree of branching is 99.9-100%. For the definition of “degree of branching” see H. Frey et al., Acta Polym. 1997, 48, 30 and see Sunder et al., Chem. Eur. J. 2000, 6 (14), 2499-2506. The degree of branching may be calculated using “inverse-gated” 13NMR spectra.

The polyimide B) may be produced by employing the polyisocyanate (b1) and polycarboxylic acid (b3)/anhydride (b3) in a molar ratio in which the molar proportion of NCO groups to COOH groups is in the range from 1:3 to 3:1, preferably 1:2 to 2:1. An anhydride group of formula CO—O—CO counts as two COOH groups.

The polyimide B) is preferably produced at temperatures in the range from 50° C. to 200° C., preferably 50° C. to 140° C., particularly preferably 50° C. to 100° C.

The compounds B) may be produced in the presence of a solvent or solvent mixture. Examples of suitable solvents are N-methylpyrrolidone (NMP), N-ethylpyrrolidone, dimethylformamide (DMF), dimethylacetamide, dimethylsulfoxide, dimethylsulphone, xylene, phenol, cresol, ketones such as acetone, methyl ethyl ketone (MEK), methyl isobutyl ketone (MIBK), acetophenone, also mono- and dichlorobenzene, ethylene glycol monoethyl ether acetate and mixtures of two or more of the abovementioned solvents. The solvent(s) may be present during the entire duration of the synthesis or only during a portion of the synthesis.

The polyimide B) may further be produced under inert gas, for example under argon or under nitrogen. Especially if a water-sensitive Brønsted base is used as catalyst it is preferable to dry the inert gas and the solvent. Drying of the solvent and the inert gas can be eschewed when using water as catalyst.

Analogously to the reaction of IA with b3) polyimide B) may also be produced by reaction of b2) with b3) under the same conditions.

Polyimide B) may also be produced by reaction of b2) with b3) as described in US 2006/033225 A1.

In one variant of the polyimide (B) the NCO end groups of the polyimide (B) have been blocked with an NCO-reactive compound. This may be a secondary amine (b4) for example.

Suitable secondary amines (b4) are for example compounds of the form NHR′R″, wherein R′ and R″ may be aliphatic and/or aromatic radicals. The aliphatic radicals may be linear, cyclic and/or branched. R′ and R″ may be identical. However, R′ and R″ are not hydrogen atoms.

Suitable amines (b4) are for example dimethyl amine, di-n-butylamine or diethylamine or mixtures thereof. Dihexylamine, Di-(2-ethylhexyl)amine and dicyclohexylamine are also suitable. Diethylamine and dibutylamine are preferred.

Polyimide (B) may also be blocked with an alcohol (b5). Primary alcohols or mixtures thereof suitable. Suitable candidates from the group of primary alcohols include in particular methanol, ethanol, isopropanol, n-propanol, n-butanol, isobutanol. Methanol, isobutanol and tert-butanol are preferred. Tert-butanol is especially preferred.

Among the alternatives (b4) and (b5), (b5) is preferred.

It is thus further preferred when after the reaction of the at least one carboxylic dianhydride with the at least one isocyanate a reaction with an alcohol or an amine, preferably an alcohol, in particular tert-butanol, was carried out to react unconverted isocyanate groups.

It is preferable when the polyimide (B) has an isocyanate content of less than 1% by weight based on the total weight of the polyimide. It is especially preferable when the polyimide is isocyanate-free.

It is preferable when the ratio of weight fractions of polyalkylene terephthalate to polyimide is in the range from 1:1 to 9.9:1, preferably from 2:1 to 9:1, more preferably from 3:1 to 4:1.

The proportion of polyalkylene terephthalate based on the total weight of the molding compound is preferably at least 50% by weight, more preferably more than 50% by weight. However, the proportion may for example also be in the range from 25% by weight to 70% by weight based on the total weight of the molding compound.

The proportion of polyimide based on the total weight of the molding compound is preferably at most 50% by weight, more preferably less than 50% by weight. However, the proportion may for example also be in the range from 5% by weight to 30% by weight based on the total weight of the molding compound.

The thermoplastic molding compound according to the present invention may comprise further components in addition to a polyalkylene terephthalate and a polyimide.

As component C) the thermoplastic molding compounds according to the invention may comprise customary processing aids such as stabilizers, oxidation retarders, agents to counteract thermal degradation and ultraviolet light degradation, lubricants and release agents, colorants such as dyes and pigments, nucleating agents, plasticizers, etc. Flame retardants in particular may be present.

Examples of oxidation retarders and heat stabilizers are sterically hindered phenols and/or phosphites and amines (e.g. TAD), hydroquinones, aromatic secondary amines such as diphenylamines, various substituted representatives of these groups and mixtures thereof in concentrations of up to 1 wt % based on the weight of the thermoplastic molding compounds.

Examples of UV stabilizers, which are generally employed in amounts of up to 2% by weight based on the thermoplastic molding compound, include various substituted resorcinols, salicylates, benzotriazoles and benzophenones.

Colorants that may be added include inorganic pigments, such as carbon black, and organic pigments, for example phthalocyanines, quinacridones, perylenes, and also dyes, for example anthraquinones.

Nucleating agents that may be employed include sodium phenylphosphinate, alumina, silica.

It is further possible to employ glass particles including glass fibers in various dimensions.

Glass fibers are reinforcing and it is therefore preferable when reinforcing fibers, in particular glass fibers, are present in the thermoplastic molding compound according to the invention. The proportion is preferably 5% by weight to 70% by weight, more preferably 10% by weight to 60% by weight, yet more preferably 15% by weight to 50% by weight, yet more preferably 20% by weight to 40% by weight, in particular 30% by weight, based on the total weight of the thermoplastic molding compound according to the invention.

When component C is present it is preferable when the following proportions are present based on the total weight of the thermoplastic molding compounds according to the invention:

25% by weight to 65% by weight of polyalkylene terephthalate,

5% by weight to 30% by weight of polyimide,

5% by weight to 70% by weight of component C, preferably in the form of reinforcing fibers, in particular glass fibers.

The thermoplastic molding compound may be produced by simple mixing, for example in an extruder. After the shaping process it is possible to obtain from the molding compound a shaped article extending substantially in one dimension (thread), a shaped article extending substantially in two dimensions (film) or a shaped article extending substantially in three dimensions (shaped body).

The mechanical properties of the thermoplastic molding compound according to the invention favor the use of the thermoplastic molding compound for producing fibers, films and/or shaped bodies. The thermoplastic composition is especially suitable for producing special shaped bodies in vehicle and machine construction, for example for industrial or consumer-oriented applications. The thermoplastic molding compound may therefore be used for production of electronic components, housings, housing parts, cover flaps, bumpers, spoilers, autobody components, springs, handles, charge air pipes, motor vehicle interior applications such as instrument panels, parts of instrument panels, instrument panel carriers, covers, air ducts, air inlet meshes, sunroof casettes, roof frames, add-on parts, in particular the center console, as part of the glovebox or else of instrument binnacles.

The thermoplastic molding compound according to the invention may also be used as a coating composition for fibers, films and/or shaped bodies. The term shaped body is to be understood as referring to three-dimensional articles that are amenable to coating with a thermoplastic composition. The thickness of such coatings is generally in the range from 0.1 to 3.0 cm, preferably from 0.1 to 2.0 cm, very particularly preferably from 0.5 to 2.0 cm. Such coatings may be produced by processes known to those skilled in the art such as lamination, painting, immersion, spraying, application.

A further aspect of the invention is therefore the use of a thermoplastic molding compound according to the present invention as a coating composition or for producing fibers, films or shaped bodies and a further aspect of the present invention comprises fibers, films or shaped bodies produced from a thermoplastic molding compound according to the present invention.

### EXAMPLES

1. Production of Polyimides

1.1. Production of PMDI-MDI-PDA-tBuOH (PI-1)

Reagents and Reactants:

42.00 g (0.192 mol) of 1,2,4,5-benzentetracarboxylic dianhydride (PDA)

18.43 g (0.0275 mol) of Lupranat® M20 (oligomeric MDI, polyMDI, PMDI)

6.88 g (0.0275 mol) of MDI

29.47 g (0.398 mol) of tert-butanol

144.2 ml of NMP

Reaction Procedure:

In a standard stirring apparatus comprising a 500 ml four-necked flask fitted with a dropping funnel, a Teflon stirrer, a reflux condenser and a thermometer, 1,2,4,5-benzentetracarboxylic dianhydride was dissolved in NMP at 80° C. with stirring. A mixture of Lupranat® M20 and MDI was added dropwise to the solution under a nitrogen atmosphere and the oil bath temperature was maintained at 80° C. A slightly exothermic reaction with evolution of gas was observable. The mixture was maintained at 80° C. for 3 hours with stirring.

After cooling of the reaction mixture to 50° C., tert-butanol was slowly added via the dropping funnel. The course of the reaction was monitored by IR measurement. After complete disappearance of the NCO band the solution was distilled at 80° C. under vacuum (20 mbar) to remove excess tert-butanol.

The polyimide solution was added dropwise to a water bath, thus causing the polyimide to precipitate as a yellow powder.

1.2. Production of Further Polyimides

Further polyimides were produced by analogy to the production process at 1.1. The composition of all of the polyimides is apparent from the following table:

| Polyimide | Composition | Proportions | T_{g} (° C.) |
|---|---|---|---|
| PI-1 | PMDI-MDI-PDA-^{t}BuOH | 0.5-0.5-3.5-excess | 225 |
| PI-2 | PMDI-MDI-PDA-^{t}BuOH | 0.75-0.25-3.5-excess | 238 |
| PI-3 | PMDI-TDI80*-PDA-^{t}BuOH | 0.4-0.6-3.5-excess | 233 |
| PI-4 | PMDI-TDI80*-PDA-^{t}BuOH | 0.3-0.7-3.5-excess | 219 |
| PI-5 | PMDI-TDI80*-PDA** | 0.3-0.7-3.5 | 242 |

*TDI80 = (20:80 mixture of 2,6- and 2,4-toluene diisocyanate)
**no addition of tert-butanol

2. Production of Molding Materials

To produce the molding compounds (FM-1 to FM-5) mixtures of the polyimides with polybutylene terephthalate (Ultradur® B4500, PBT) were added to an Xplore MC 15 mini extruder in an amount of 15 g and mixed at a temperature of 260° C. to 300° C. at 80 rpm for 3 minutes. The obtained molding compounds showed a single T_{g} value in DSC measurement. The mixing ratios and obtained T_{g} values are summarized in the following table:

| | FM-1 | FM-2 | FM-3 | FM-4 | FM-5 |
|---|---|---|---|---|---|
| PBT | 100 | 75 | 75 | 89.4 | 75 |
| PI-1 | | 25 | | | |
| PI-2 | | | 25 | | |
| PI-3 | | | | 10.6 | |
| PI-4 | | | | | 25 |
| T_{g} (° C.) | 39 | 64.9 | 59 | 50.2 | 82.5 |

As is apparent the addition of PI made it possible to markedly elevate the T_{g} of polybutylene terephthalate.

To produce the molding compounds FM6 to FM9 the components were mixed in a ZSK 18 extruder at a barrel temperature of 260° C., a screw speed of 300 rpm and a throughput of 6 kg/h, pelletized and subsequently dried in a drying cabinet at 100° C. for 6 hours. The tensile bars were produced by injection molding at a melt temperature of 260° C. and a mold temperature of 60° C.

The obtained test specimens were tested at 23° C. according to ISO 527. The results obtained are summarized in the table that follows.

The glass fiber used was an E-glass fiber endowed with an epoxy size; staple fibers were employed.

| | FM-6 | FM-7 | FM-8 | FM-9 |
|---|---|---|---|---|
| PBT | 70 | 59.5 | 56 | 52.5 |
| PI-4 | — | 10.5 | 14 | 17.5 |
| Glass fibers | 30 | 30 | 30 | 30 |
| Tg [° C.] | 45 | 57 | 62 | 66 |
| Modulus of | 9170 | 9350 | 9400 | 9420 |
| elasticity | | | | |
| [MPa] | | | | |
| Tear strength | 124 | 134 | 136 | 134 |
| [MPa] | | | | |

The glass fiber-reinforced molding compounds exhibit not only an elevated glass transition temperature but surprisingly also higher stiffness and strength.

1. A thermoplastic molding compound comprising a polyalkylene terephthalate and a polyimide, wherein the molding compound has a single glass transition temperature in DSC measurement, wherein the polyimide is obtained by reaction of at least one carboxylic dianhydride with at least one isocyanate, wherein the isocyanate comprises at least two isocyanate groups and wherein after the reaction of the at least one carboxylic dianhydride with the at least one isocyanate unconverted isocyanate groups were blocked with an alcohol or an amine and wherein the ratio of polyalkylene terephthalates are to polyimide is in the range from 1:1 to 9.9:1.

2. The thermoplastic molding compound according to claim 1, wherein the single glass transition temperature has a value of at least 45° C.

3. The thermoplastic molding compound according to claim 1, wherein the at least one carboxylic dianhydride is 1,2,4,5-benzenetetracarboxylic anhydride.

4. The thermoplastic molding compound according to claim 1, wherein the at least one isocyanate is 4,4′-diphenylmethane diisocyanate, oligomeric 4,4′-diphenylmethane diisocyanate, 2,4-toluene diisocyanate, 2,6-toluene diisocyanate, or a mixture thereof.

5. The thermoplastic molding compound according to claim 1, wherein a mixture of oligomeric 4,4′-diphenylmethane diisocyanate, 2,4-toluene diisocyanate, and 2,6-Toluoldiisocyanat has been employed.

6. The thermoplastic molding compound according to claim 5, wherein the molar ratio of 2,4-toluene diisocyanate to 2,6-toluene diisocyanate is in the range from 1:1 to 10:1.

7. The thermoplastic molding compound according to claim 5, wherein the molar ratio of oligomeric 4,4′-diphenylmethane diisocyanate to the sum of 2,4-toluene diisocyanate and 2,6-toluene diisocyanate is in the range from 1:1 to 0.1:1.

8. The thermoplastic molding compound according to claim 1, wherein after the reaction of the at least one carboxylic dianhydride with the at least one isocyanate, a reaction with an alcohol is carried out.

9. The thermoplastic molding compound according to claim 1, wherein the alcohol is tert-butanol.

10. The thermoplastic molding compound according to claim 1, wherein the polyimide has an isocyanate content of less than 1% by weight based on the total weight of the polyimide.

11. The thermoplastic molding compound according to claim 1, wherein the ratio of the weight fractions of polyalkylene terephthalate to polyimide is in the range from 2:1 to 9:1.

12. The thermoplastic molding compound according to claim 1, wherein the proportion of polyalkylene terephthalate based on the total weight of the molding compound is at least 50% by weight.

13. The thermoplastic molding compound according to claim 1, wherein reinforcing fibers, in particular glass fibers, are also present.

14. (canceled)

15. A fiber, film or shaped body produced from a thermoplastic molding compound according to claim 1.

16. (canceled)

17. The thermoplastic molding compound according to claim 1, wherein the polyalkylene terephthalate is polybutylene terephthalate.

18. The thermoplastic molding compound according to claim 1, wherein the polyimide is isocyanate-free.
